(19) United States
(12) Patent Application Publication
(10) Pub. No.: US 2015/0286628 A1
(43) Pub. Date: Oct. 8, 2015

(54) INFORMATION EXTRACTION SYSTEM, INFORMATION EXTRACTION METHOD, AND INFORMATION EXTRACTION PROGRAM

(71) Applicant: NEC CORPORATION, Minato-ku, Tokyo (JP)

(72) Inventor: Susumu Akamine, Tokyo (JP)

(73) Assignee: NEC Corporation, Minato-ku, Tokyo (JP)

(21) Appl. No.: 14/438,301

(22) PCT Filed: Oct. 25, 2013
(86) PCT No.: PCT/JP2013/078930

§ 371 Date: Apr. 24, 2015

(30) Foreign Application Priority Data
Oct. 26, 2012 (JP) 2012-236688

(51) Int. Cl. G06F 17/27; G06F 17/30

(52) U.S. Cl. CPC G06F 17/2705; G06F 17/30684

(57) ABSTRACT

An opinion/emotion word detection unit browses an opinion/emotion dictionary, finds matches, detects opinion/emotion words in an obtained character string, and applies absolute polarity thereto. A term polarity determination unit detects terms on the basis of co-occurrence with opinion/emotion words, and determines the polarity of the terms on the basis of the absolute polarity of the opinion/emotion words. A determination range expansion unit expands word strings including words connected to terms, and determines the polarity of a word string for determination. A series of individual determinations are repeated, and a determination tallying unit tallies the individual determination results for each word string for determination. A consolidated polarity determination unit calculates a ratio (N) on the basis of the number of positive determinations and the number of negative determinations, and makes a consolidated determination. An expression extraction unit extracts the consolidated determination result and outputs same to an expression word string dictionary.

This application is a National Stage Entry of PCT/JP2013/078930 filed on Oct. 25, 2013, which claims priority from Japanese Patent Application 2012-236688 filed on Oct. 26, 2012, the contents of all of which are incorporated herein by reference, in their entirety.

### TECHNICAL FIELD

The present invention relates to an information extraction system, an information extraction method, and an information extraction program, and in particular, to an information extraction system, an information extraction method, and an information extraction program used for extracting word strings relevant to positive expressions and negative expressions from a text set.

### BACKGROUND ART

Over the recent years, a large number of pieces of text information regarding products/services have been accumulated through a bulletin board on the Internet, answering cases of a contact center, and the like. When being able to be automatically extracted from these pieces of text information, positive expressions and negative expressions regarding the use of products/services are usable for an improvement of operational efficiency in the contact center and in addition, are applicable to various purposes such as risk monitoring, marketing, and the like. When, for example, a negative expression representing a product failure such as “The battery is quickly discharged” and the like can be extracted from the bulletin board on the Internet and past inquiry cases in the contact center, it is possible to construct a Q & A collection having high comprehensiveness using failure information.

To extract these positive expressions and negative expressions, as a technical basis therefor, it is important to construct a dictionary of positive expressions and negative expressions. However, there are a large variety of positive expressions and negative expressions, which furthermore vary depending on the field. Therefore, it is difficult to manually construct and maintain the dictionary and then it is desirable to automatically construct the dictionary. For example, the noun “error” is a negative expression for “An error has occurred” but a positive expression for “An error has been suppressed.” Further, the verb “destroyed” is usually a negative expression in many cases but “Cancer cells have been destroyed” is a positive expression.

As one example of a method for automatically extracting such a large variety of expressions, PTL 1 describes a method for extracting a failure expression from a text. In PTL 1, failure information is extracted using a continuative modification expression and the like for indicating suddenness such as “suddenly,” “abruptly,” and the like and a continuative modification expression indicating normality such as “properly,” “solidly,” and the like.

### CITATION LIST

### Patent Document

PTL 1: Japanese Laid-open Patent Publication No. 2011-232902

### SUMMARY OF INVENTION

### Technical Problem

However, there are the following problems in the related art disclosed by PTL 1.

Firstly, there is a problem regarding comprehensiveness. The related art extracts a failure expression based on co-occurrence with a continuative modifier indicating suddenness and a continuative modifier indicating normality, but a co-occurrence frequency with the continuative modifier indicating suddenness and the continuative modifier indicating normality is limited in a text set. Therefore, failure expressions other than the above are not detected. It is difficult to extract positive expressions and negative expressions with high comprehensiveness (less omissions) by applying the related art.

Secondly, there is a problem regarding preciseness. The related art does not consider a range of an expression to be extracted. When a positive expression and a negative expression are extracted from an expression such as “Cancer cells have been destroyed” and the like, for example, “destroy” is generally a negative expression in many cases and therefore, “Cancer cells are destroyed” may be extracted erroneously as a negative expression. In such a case that the same declinable word is included but a difference in length between words causes a polarity reverse, highly precise extraction is not performable.

The present invention is intended to solve the above-described first problem and a first object of the present invention is to provide an information extraction system, a method, and a program capable of comprehensively extracting positive expressions and negative expressions.

The present invention is intended to solve the above-described second problem and a second object of the present invention is to provide an information extraction system, a method, and a program capable of precisely extracting polarity even when the polarity is reversed depending on a range of an expression.

### Solution to Problem

To solve the above problem, according to an exemplary embodiment of the present invention, there is provided an information extraction system including:

an opinion/emotion dictionary that stores opinion/emotion words (or word strings) relevant to absolute positive expressions and opinion/emotion words (or word strings) relevant to absolute negative expressions, the words having a polarity remaining unchanged regardless of a context;

a language analysis means for acquiring unit that acquires an optional character string from a text and performing performs language analysis for the character string to divide the character string into words and provide a prototype and a part of speech for each of the words;

an opinion/emotion word detection means for detecting an opinion/emotion word (or a word string) from the acquired character string by preforming a matching between the prototype of each of words as the analysis result by the language analysis means and an opinion/emotion word (or a word string) in the opinion/emotion dictionary;

a declinable word polarity determination means for determining a polarity of a declinable word based on an absolute polarity of the opinion/emotion word (or the word string) by detecting the declinable word before and after the opinion/emotion word (or the word string) from the acquired character string based on co-occurrence with the opinion/emotion word (or the word string);

a determination range expansion means for determining polarity by expanding a polarity determination range from the declinable word to word strings obtained by linking the declinable word with at least one word before and after the declinable word;

a determination number tallying means for tallying a positive determination number and a negative determination number for each determination target word string by repeating a single determination of polarities of the declinable word and the expanded determination target word strings for another character string included in the text;

a consolidated polarity determination means for performing a consolidated determination whether the determination target word strings are a positive expression or a negative expression based on the positive determination number and the negative determination number; and

an expression extraction means for extracting a word string (or a word) relevant to a positive expression and a word string (or a word) relevant to a negative expression based on the determination result of the consolidated polarity determination means.

To solve the above problem, according to an exemplary embodiment of the present invention, there is provided an information extraction system including:

an opinion/emotion dictionary that stores opinion/emotion words (or word strings) relevant to absolute positive expressions and opinion/emotion words (or word strings) relevant to absolute negative expressions, the words having a polarity remaining unchanged regardless of a context;

a language analysis unit that acquires an optional character string from a text and performs language analysis for the character string to divide the character string into words and provide a prototype and a part of speech for each of the words;
an opinion/emotion word detection unit that detects an opinion/emotion word (or a word string) from the acquired character string by preforming a matching between the prototype of each of words as the analysis result by the language analysis unit and an opinion/emotion word (or a word string) in the opinion/emotion dictionary;

a declinable word polarity determination unit that determines a polarity of a declinable word based on an absolute polarity of the opinion/emotion word (or the word string) by detecting the declinable word before and after the opinion/emotion word (or the word string) from the acquired character string based on co-occurrence with the opinion/emotion word (or the word string);

a determination range expansion unit that determines polarity by expanding a polarity determination range from the declinable word to word strings obtained by linking the declinable word with at least one word before and after the declinable word;

a determination number tallying unit that tallies a positive determination number and a negative determination number for each determination target word string by repeating a single determination of polarities of the declinable word and the expanded determination target word strings for another character string included in the text;

a first consolidated polarity determination unit that temporarily determines whether the determination target word strings are a positive expression or a negative expression based on the positive determination number and the negative determination number;

a second consolidated polarity determination unit that finally determines only a polarity of a second word string when a first word string (including a declinable word) and the second word string including the first word string and being longer than the first word string exist and a polarity of the first word string and the polarity of the second word string are reversed by the first consolidated polarity determination unit; and

an expression extraction unit that extracts a word string (or a word) relevant to a positive expression and a word string (or a word) relevant to a negative expression based on the determination result of the second consolidated polarity determination unit.

To solve the above problem, according to an exemplary embodiment of the present invention, there is provided an information extraction method including:

providing a prototype and a part of speech for each word by acquiring an optional character string from a text, performing language analysis for the character string, and dividing the character string into words;

detecting an opinion/emotion word (or a word string) from the acquired character string by referring to an opinion/emotion dictionary that stores opinion/emotion words (or word strings) relevant to absolute positive expressions and opinion/emotion words (or word strings) relevant to absolute negative expressions, the words having a polarity remaining unchanged regardless of a context and preforming a matching between the prototype of each of words as the language analysis result and an opinion/emotion word (or a word string) in the opinion/emotion dictionary;

determining a polarity of a declinable word based on an absolute polarity of the opinion/emotion word (or the word string) by detecting the declinable word before and after the opinion/emotion word (or the word string) from the acquired character string based on co-occurrence with the opinion/emotion word (or the word string);

determining polarity by expanding a polarity determination range from the declinable word to word strings obtained by linking the declinable word with at least one word before and after the declinable word;

tallying a positive determination number and a negative determination number for each determination target word string by repeating a single determination of polarities of the declinable word and the expanded determination target word strings for another character string included in the text;

performing a consolidated determination whether the determination target word strings are a positive expression or a negative expression based on the positive determination number and the negative determination number; and

extracting a word string (or a word) relevant to a positive expression and a word string (or a word) relevant to a negative expression based on the consolidated determination result.

To solve the above problem, according to an exemplary embodiment of the present invention, there is provided an information extraction program causes a processing device to execute:

processing for acquiring an optional character string from a text and performing language analysis for the character string to divide the character string into words and provide a prototype and a part of speech for each of the words;

processing for detecting an opinion/emotion word (or a word string) from the acquired character string by referring to an opinion/emotion dictionary that stores opinion/emotion words (or word strings) relevant to absolute positive expressions and opinion/emotion words (or word strings) relevant to absolute negative expressions, the words having a polarity remaining unchanged regardless of a context and preforming a matching between the prototype of each of words as the language analysis result and an opinion/emotion word (or a word string) in the opinion/emotion dictionary;

processing for determining a polarity of a declinable word based on an absolute polarity of the opinion/emotion word (or the word string) by detecting the declinable word before and after the opinion/emotion word (or the word string) from the acquired character string based on co-occurrence with the opinion/emotion word (or the word string);

processing for determining polarity by expanding a polarity determination range from the declinable word to word strings obtained by linking the declinable word with at least one word before and after the declinable word;

processing for tallying a positive determination number and a negative determination number for each determination target word string by repeating a single determination of polarities of the declinable word and the expanded determination target word strings for another character string included in the text;

processing for performing a consolidated determination whether the determination target word strings are a positive expression or a negative expression based on the positive determination number and the negative determination number; and

processing for extracting a word string (or a word) relevant to a positive expression and a word string (or a word) relevant to a negative expression based on the consolidated determination result.

### Advantageous Effects of Invention

The present invention makes it possible to comprehensively extract positive expressions and negative expressions.

Further, the present invention makes it possible to precisely extract polarity even when the polarity is reversed depending on a range of an expression.

### BRIEF DESCRIPTION OF DRAWINGS

FIG. 1 is a functional block diagram of an information extraction system in a first exemplary embodiment.

FIG. 2 is an operational flowchart illustrating processing contents of a processing device in the first exemplary embodiment.

FIG. 3 is a chart illustrating an example in which acquired character strings are provided with IDs.

FIG. 4 is a chart illustrating one example of a language analysis result.

FIG. 5 is a chart illustrating one example of an opinion/emotion dictionary.

FIG. 6 is a chart illustrating one example of a detection result of opinion/emotion words.

FIG. 7 is a chart illustrating one example of a polarity determination result of declinable words.

FIG. 8 is a chart illustrating one example of a tallied result.

FIG. 9 is a chart illustrating one example of a consolidated determination result.

FIG. 10 is a functional block diagram of an information extraction system in a second exemplary embodiment.

FIG. 11 is an operational flowchart illustrating processing contents of a processing device in the second exemplary embodiment.

FIG. 12 is a chart illustrating one example of a consolidated determination result in the second exemplary embodiment.

### DESCRIPTION OF EMBODIMENTS

### First Exemplary Embodiment

(Configuration)

A configuration of an exemplary embodiment of the present invention will be described in detail with reference to a functional block diagram.

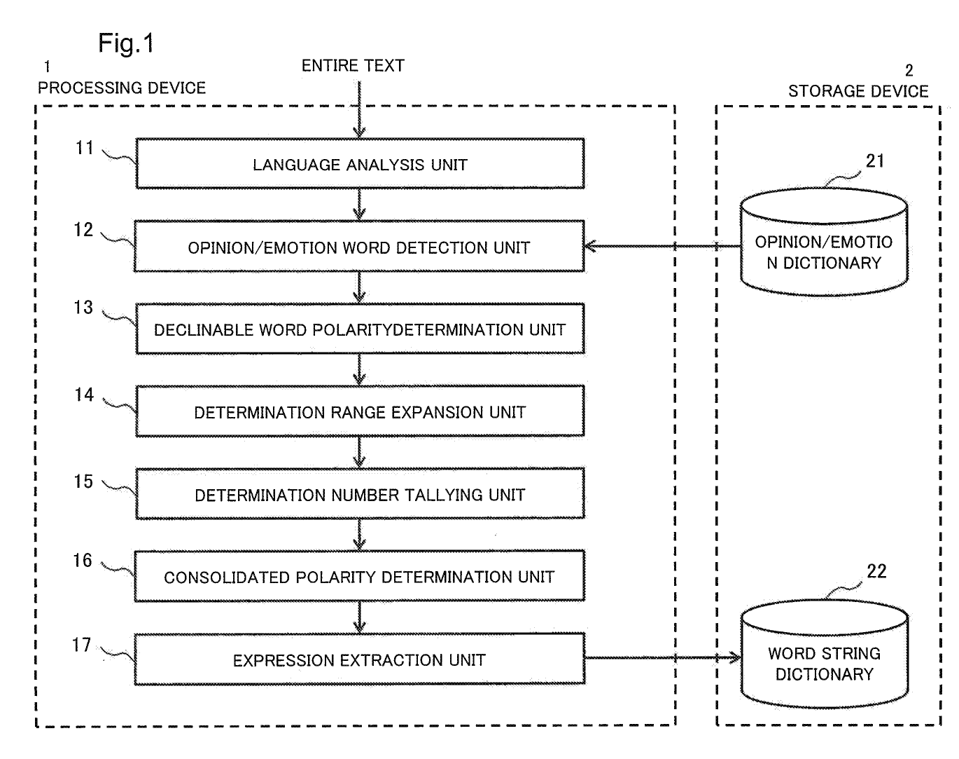

FIG. 1 is a functional block diagram of an information extraction system according to the present exemplary embodiment. The information extraction system includes a processing device 1 that operates by program control and a storage device 2 that stores information.

The processing device 1 includes a language analysis unit 11, an opinion/emotion word detection unit 12, a declinable word polarity determination unit 13, a determination range expansion means unit 14, a determination number tallying unit 15, a consolidated polarity determination unit 16, and an expression extraction unit 17.

The storage device 2 includes an opinion/emption dictionary 21 and an expression word string dictionary 22.

The language analysis unit 11 acquires an optional character string from an input text and performs language analysis for the acquired character string to divide the character string into words and provide a prototype and a part of speech for each word.

The opinion/emotion word detection unit 12 performs a matching between the prototype of each of words as the analysis result by the language analysis unit 11 and an opinion/emotion word (or a word string, and the same applies hereinafter) in the opinion/emotion dictionary 21. When detecting a word matched with an opinion/emotion word in the acquired character string, the opinion/emotion word detection unit 12 detects the word as the opinion/emotion word, and further provides information regarding an absolute polarity stored in the opinion/emotion dictionary 21 for the word. However, when the opinion/emotion word is detected together with a negative word (e.g., not), polarity may be reversed and therefore, the word may be excluded. When it is clear that polarity is reversed, a polarity to be reversed may be stored in the opinion/emotion dictionary 21.

The declinable word polarity determination unit 13 detects a declinable word before and after the opinion/emotion word from the acquired character string based on co-occurrence with the opinion/emotion word. The declinable word polarity determination unit 13 determines a polarity of the declinable word based on the absolute polarity of the opinion/emotion word provided by the opinion/emotion word detection unit 12.

The declinable word refers to a word having a conjugation, being usable alone as a predicate, and predicating the motion/presence/nature/state of a thing among the independent words. As the sub-classification thereof, there are three parts of speech that are verb, adjective, and adjective verb.

For a polarity determination of a specific declinable word, a distance from an opinion/emotion word and the number of appearances are used. When, for example, an opinion/emotion word relevant to an absolute positive expression and an opinion/emotion word relevant to an absolute negative expression are present before and after a declinable word to be targeted, the declinable word polarity determination unit 13 determines an absolute polarity of a closer opinion/emotion word as the same polarity. In other words, when an opinion/emotion word relevant to an absolute positive expression is present closer to the declinable word, the declinable word polarity determination unit 13 determines a polarity of the declinable word to be positive, and when an opinion/emotion word relevant to an absolute negative expression is present closer to the declinable word, the declinable word polarity determination unit 13 determines a polarity of the declinable word to be negative. A distance between the declinable word and the opinion/emotion word is limited within N words (e.g., 10 words). Alternatively, a limitation to the same sentence or anteroposterior N sentences (e.g., anteroposterior 2 sentences) is applicable. Further, when a distance from an opinion/emotion word relevant to an absolute positive expression and a distance from an opinion/emotion word relevant to an absolute negative expression are considered to be the same or substantially the same (for example, the respective distances include 6 words and 7 words and the difference is one word), the declinable word polarity determination unit 13 may perform a determination using the numbers of appearances in the same document of opinion/emotion words relevant to absolute positive expressions and opinion/emotion words relevant to absolute negative expressions appearing.

The determination range expansion unit 14 expands a polarity determination range from the declinable word detected and determined by the declinable word polarity determination unit 13. Specifically, the declinable word is linked with 1 to N (e.g., 3) words before the declinable word. In some cases, 1 to N words after the declinable word is linkable. Thereby, N expanded determination target word strings can be created. These determination target word strings are provided with the same polarity as the declinable word.

When the language analysis unit 11 divides, for example, a word string of “The battery is quickly discharged” into the words “battery,” “is,” “quickly,” and “discharged” and the declinable word polarity determination unit 13 determines that a polarity of the declinable word “discharged” is negative, the determination range expansion unit 14 determines that polarities of the expanded determination target word strings “quickly discharged,” “is quickly discharged,” and “battery is quickly discharged” are negative when N=3.

The language analysis unit 11, the opinion/emotion word detection unit 12, the declinable word polarity determination unit 13, and the determination range expansion unit 14 acquire an optional character string from the input text, and repeat a series of processing operations. This series of processing operations for determining polarities of a declinable word and determination target word strings is referred to as a single determination. Even for the same determination target word string, a single determinant result may be positive or negative.

The determination number tallying unit 15 tallies a positive determination number and a negative determination number for each determination target word string (partially, a declinable word (a word) is included and the same applies hereinafter) with respect to the entire text, based on the result of the single determination.

The consolidated polarity determination unit 16 calculates a ratio N based on the positive determination number and the negative determination number for each determination target word string and performs a consolidated determination in which, for example, when N>5, a positive expression is determined and when N<0.2, a negative expression is determined. The consolidated determination is performed by consolidating a large number of single determination results.

The expression extraction unit 17 extracts a word string relevant to a positive expression and a word string relevant to a negative expression based on the determination result of the consolidated polarity determination unit 16 and outputs these word strings to the expression word string dictionary 22. The word strings may be output to a monitor at the same time.

The opinion/emotion dictionary 21 stores opinion/emotion words relevant to absolute positive expressions and opinion/emotion words relevant to absolute negative expressions having a polarity remaining unchanged regardless of a context.

The expression word string dictionary 22 stores word strings relevant to positive expressions and word strings relevant to absolute negative expressions as extraction results of the information extraction system.

(Operations)

Next, operations of the exemplary embodiment of the present invention will be described in detail with reference to a flowchart.

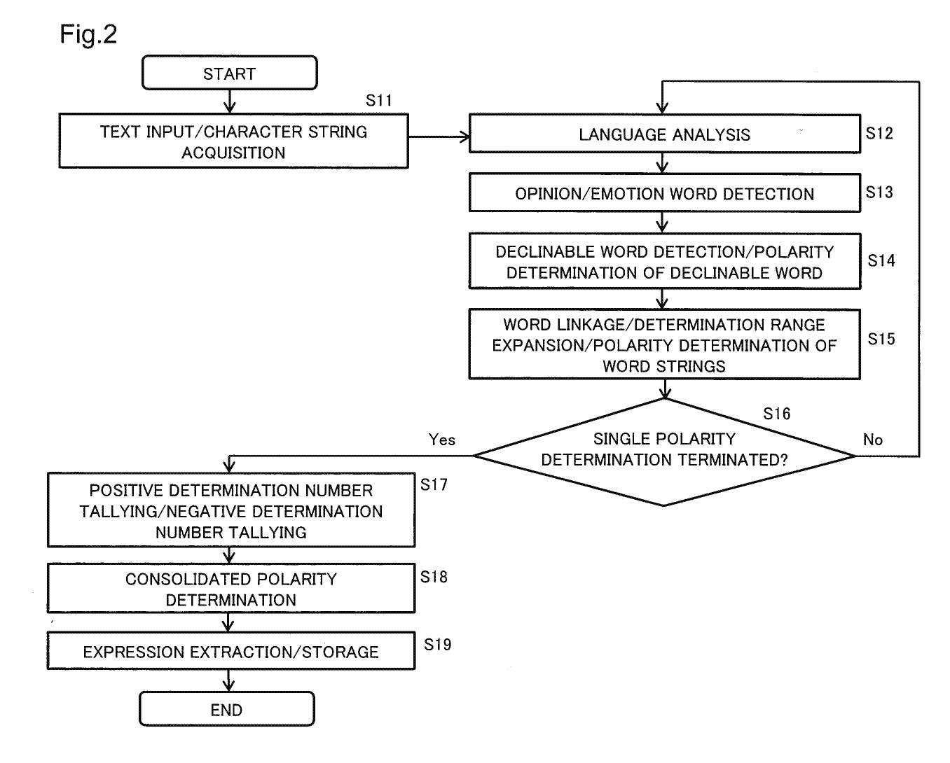

FIG. 2 is an operational flowchart illustrating processing contents of the processing device 1.

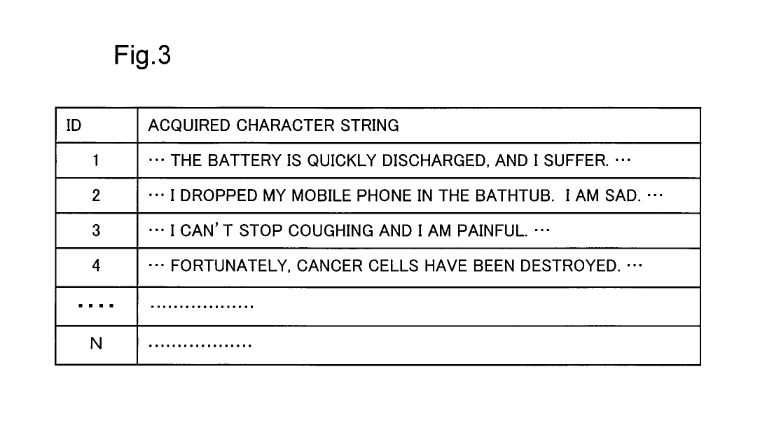

The language analysis unit 11 acquires an optional character string from an input text (step S11). The acquired character string is provided with an ID. FIG. 3 illustrates an example in which acquired character strings are provided with IDs. A character string such as “ . . . The battery is quickly discharged, and I suffer . . . ” and the like is acquired.

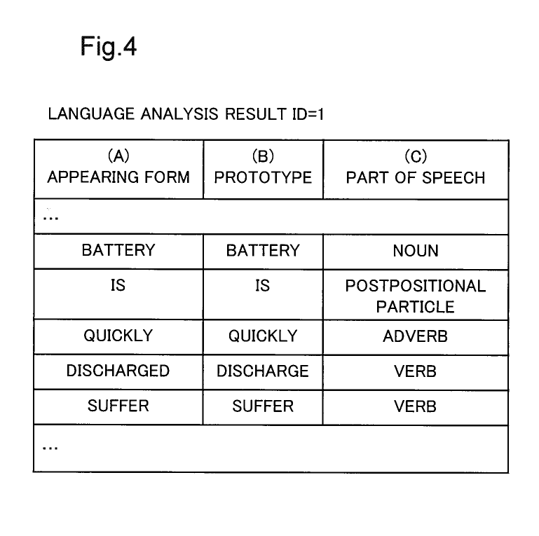

The language analysis unit 11 performs language analysis for the acquired character string using an existing technique such as morphological analysis and the like, divides the character string into words, and provides a prototype and a part of speech for each word (step S12). FIG. 4 illustrates a language analysis result of “ . . . The battery is quickly discharged, and I suffer . . . ” of ID=1 “The battery is quickly discharged, and I suffer” is divided into words of “battery,” “is,” “quickly,” “discharged,” and “suffer,” and each divided word is provided with a prototype and a part of speech.

The opinion/emotion word detection unit 12 refers to the opinion/emotion dictionary 21, performs a matching, and detects an opinion/emotion word from the acquired character string (step S13).

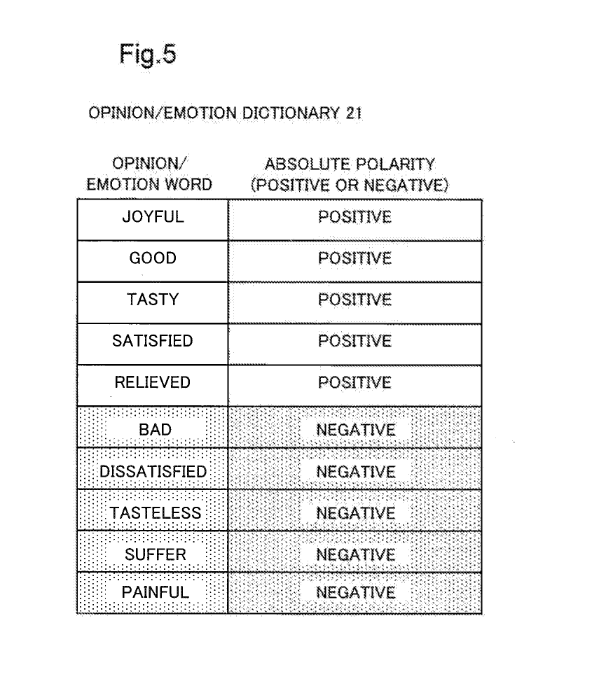

FIG. 5 illustrates one example of the opinion/emotion dictionary 21. The opinion/emotion word is provided with an absolute positive or absolute negative polarity. For example, “joyful,” “good,” “tasty,” “satisfied,” and “relieved,” are always positive independently of a context where any one of these words appears, and “bad,” “dissatisfied,” “tasteless,” “suffer,” and “painful” are always negative independently of a context where any one of these words appears. “Suffer” is stored in the opinion/emotion dictionary 21 as an opinion/emotion word relevant to an absolute negative expression.

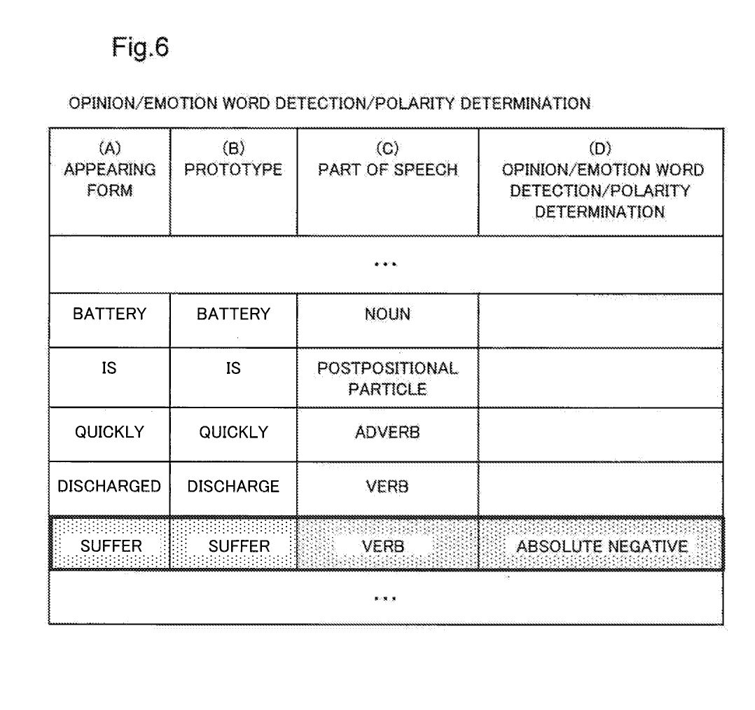

A matching is performed for each word of “battery,” “is,” “quickly,” “discharged,” and “suffer” as a language analysis result and the opinion/emotion word “suffer” is detected. Further, suffer” is provided with an absolute negative polarity. FIG. 6 illustrates one example of a detection result of the opinion/emotion words.

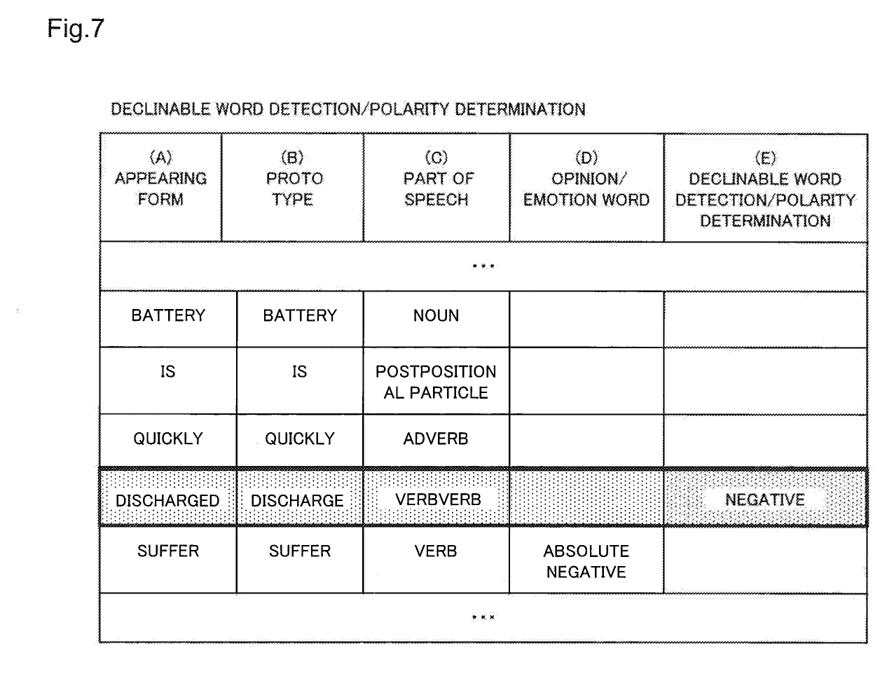

The declinable word polarity determination unit 13 detects a declinable word based on co-occurrence with the opinion/emotion word and determines a polarity of the declinable word based on the absolute polarity of the opinion/emotion word (step S14). Specifically, a verb, an adjective, or an adjective verb having not been detected by the opinion/emotion word detection unit 12 is detected as a declinable word. In the above, “discharged” corresponds to the declinable word. Further, the opinion/emotion word “suffer” before and after the declinable word is detected and a polarity of the declinable word “discharged” is determined to be negative based on the absolute polarity (absolute negative) of the opinion/emotion word “suffer.” FIG. 7 illustrates one example of a polarity determination result of the declinable words.

The determination range expansion unit 14 expands the declinable word to word strings by linking the declinable word with 1 to N (e.g., 3) words before the declinable word and determines polarities of the determination target word strings (step S15). When N=3, “quickly,” “is/quickly,” and “battery/is/quickly” before the declinable word “discharged” are linked and the declinable word “discharged” is expanded to the determination target word strings “quickly discharged,” “is quickly discharged,” and “battery is quickly discharged.” All of these determination target word strings are provided with the same polarity (negative) as for the declinable word “discharged.”

The language analysis unit 11, the opinion/emotion word detection unit 12, the declinable word polarity determination unit 13, and the determination range expansion unit 14 repeat a series of processing operations (single determination) of steps S12 to 15 in all of the IDs of step S11, and after the single determination is performed for all of the IDs, the processing moves to the next step (step S16).

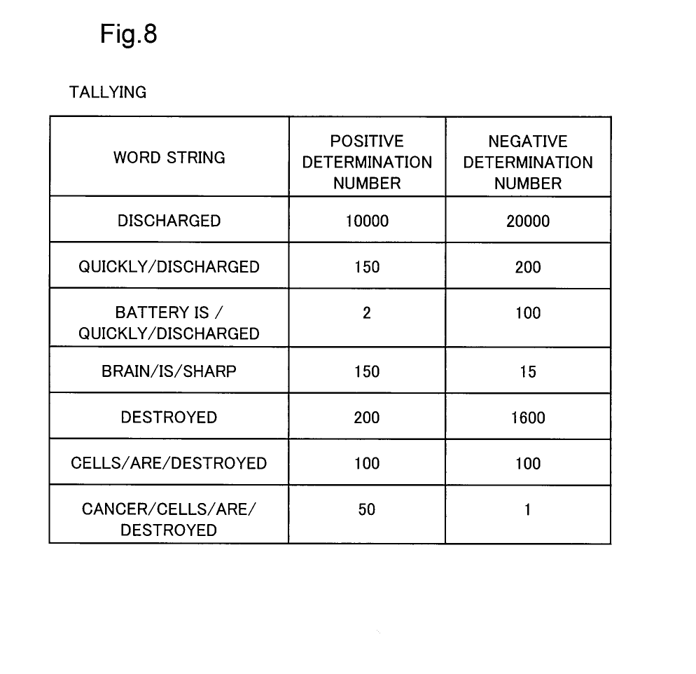

The determination number tallying unit 15 tallies a positive determination number and a negative determination number for each determination target word string (partially, a declinable word (a word) is included and the same applies hereinafter) with respect to the entire text based on a result of the single determination (step S17). FIG. 8 illustrates one example of a tallied result. For example, in the declinable word “kireru” (in Japanese, equivalent to “discharged” or “sharp” depending on the case in the figure),” the positive determination number is 10000 and the negative determination number is 20000. In other words, it is indicated that the declinable word “kireru” is frequently used in a negative expression such as “The battery is quickly kireru (discharged)” but may be used in a positive expression such as “Your brain is kireru (sharp).”

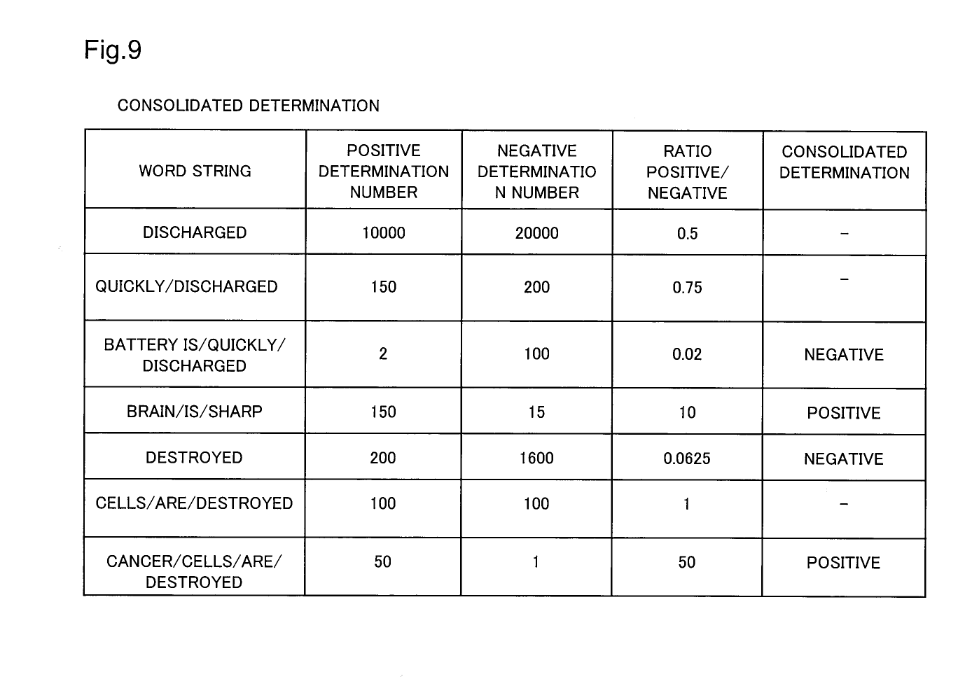

The consolidated polarity determination unit 16 calculates a ratio N based on the positive determination number and the negative determination number with respect to each determination target word string and performs a consolidated determination in such a manner that for example, when N>5, a positive expression is determined and when N<0.2, a negative expression is determined (step S18). In other words, a determination target word string in which the positive determination number is more than five times the negative determination number is determined as a positive expression, and a determination target word string in which the negative determination number is more than five times the positive determination number is determined as a negative expression. Those other than these are excluded from the determination targets. A threshold may be appropriately set. FIG. 9 illustrates one example of a consolidated determination result. The determination target word strings “Your brain is sharp” and “Cancer cells are destroyed” are determined as positive expressions, and the determination target word strings “The battery is quickly discharged” and “destroyed” are determined as negative expressions.

The expression extraction unit 17 extracts the word strings “Your brain is sharp” and “Cancer cells are destroyed” relevant to positive expressions and the word strings “The battery is quickly discharged” and “destroyed” relevant to negative expressions based on the determination result of the consolidated polarity determination unit 16 and outputs the extracted word strings to the expression word string dictionary 22 (step S19).

(Effects)

A first effect of the present exemplary embodiment is described below. The present exemplary embodiment determines polarities of a declinable word and a determination target word string based on an opinion/emotion word having an absolute polarity. A text regarding evaluations of a product always includes opinion/emotion words. Therefore, by comprehensively detecting the opinion/emotion words, the present exemplary embodiment can comprehensively extract positive expressions and negative expressions.

A second effect of the present exemplary embodiment is described below. As described above, the present exemplary embodiment determines polarities of a declinable word and a determination target word string based on an opinion/emotion word having an absolute polarity and therefore, can accurately perform a determination. Further, the present exemplary embodiment expands a determination range to word strings obtained by linking a declinable word with words and therefore, can accurately determine polarity. As can be seen from the fact that, for example, “destroyed” and “Cancer cells are destroyed” are extracted as a negative expression and a positive expression, respectively, in FIG. 9, the present exemplary embodiment can also cope with a case in which polarity is reversed due to a difference in length between words. Further, after repeating a single determination, the present exemplary embodiment tallies determination numbers and performs a consolidated determination and therefore, can perform a determination more accurately than a single determination.

### Second Exemplary Embodiment

(Configuration)

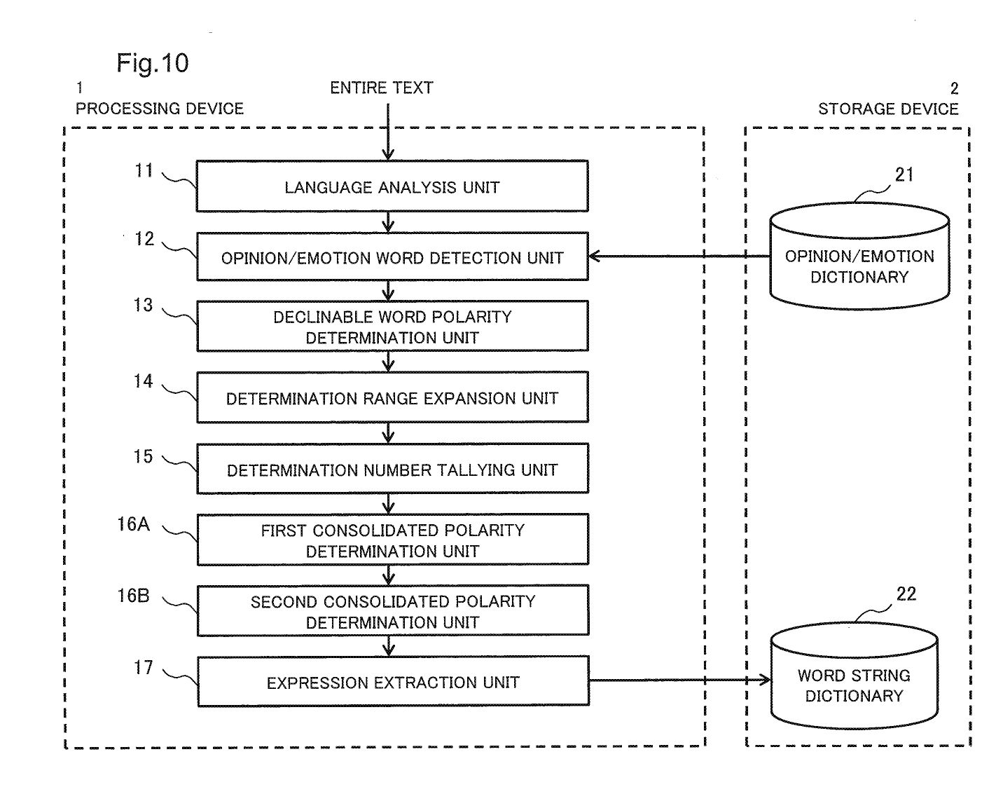

FIG. 10 is a functional block diagram of an information extraction system according to a second exemplary embodiment. There is a difference in which while the first exemplary embodiment includes the consolidated polarity determination unit 16, the second exemplary embodiment includes a first consolidated polarity determination unit 16A and a second consolidated polarity determination unit 16B. Other configurations are common to those in the first exemplary embodiment, and the same reference sign is assigned to each corresponding configuration. Description of the common configurations will be omitted.

The first consolidated polarity determination unit 16A performs a temporal determination prior to a final determination but is configured substantially in the same manner as the consolidated polarity determination unit 16 of the first exemplary embodiment.

When a first word string (including a declinable word) and a second word string including the first word string and being longer than the first word string exist and also a polarity of the first word string and a polarity of the second word string are reversed by the first consolidated polarity determination unit 16A, the second consolidated polarity determination unit 16B determines only the polarity of the second word string. In other words, the first word string is excluded from the determination targets.

(Operations)

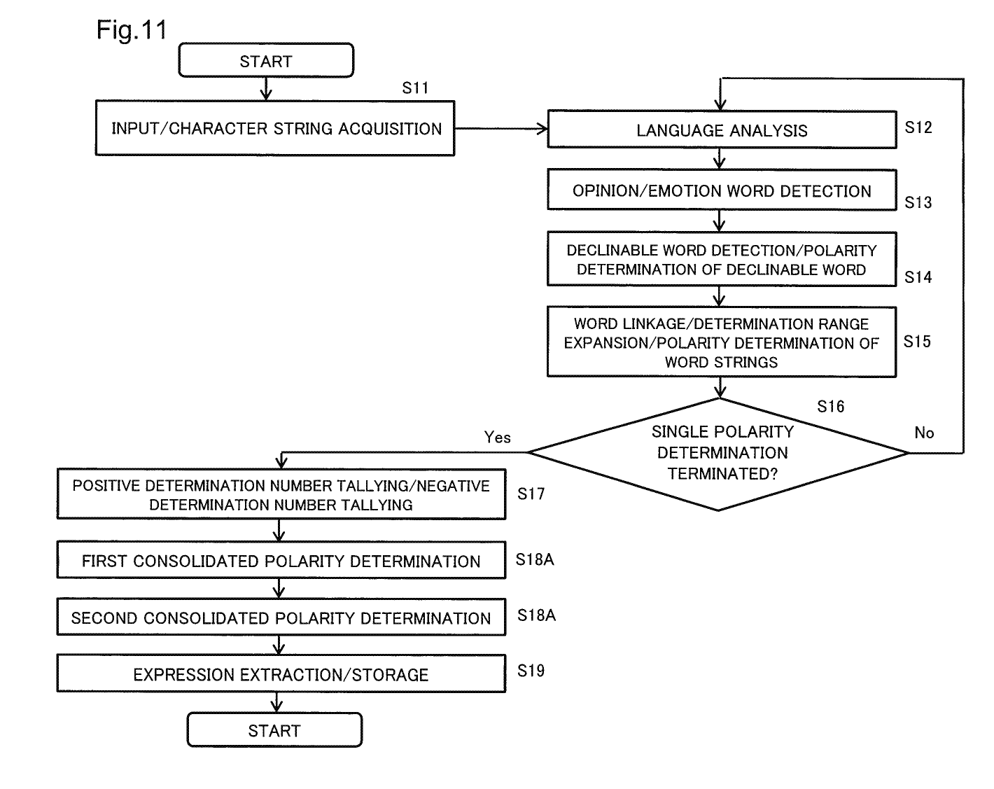

FIG. 11 is an operational flowchart illustrating processing contents of a processing device 1 according to the second exemplary embodiment. There is a difference in which while the first exemplary embodiment includes processing (step S18) relevant to a consolidated polarity determination, the second exemplary embodiment includes processing (step S18A) relevant to a first consolidated polarity determination and processing (step S18B) relevant to a second consolidated polarity determination. Other processing operations are common to the first exemplary embodiment and are assigned with the same step numbers. Description of the common steps will be omitted.

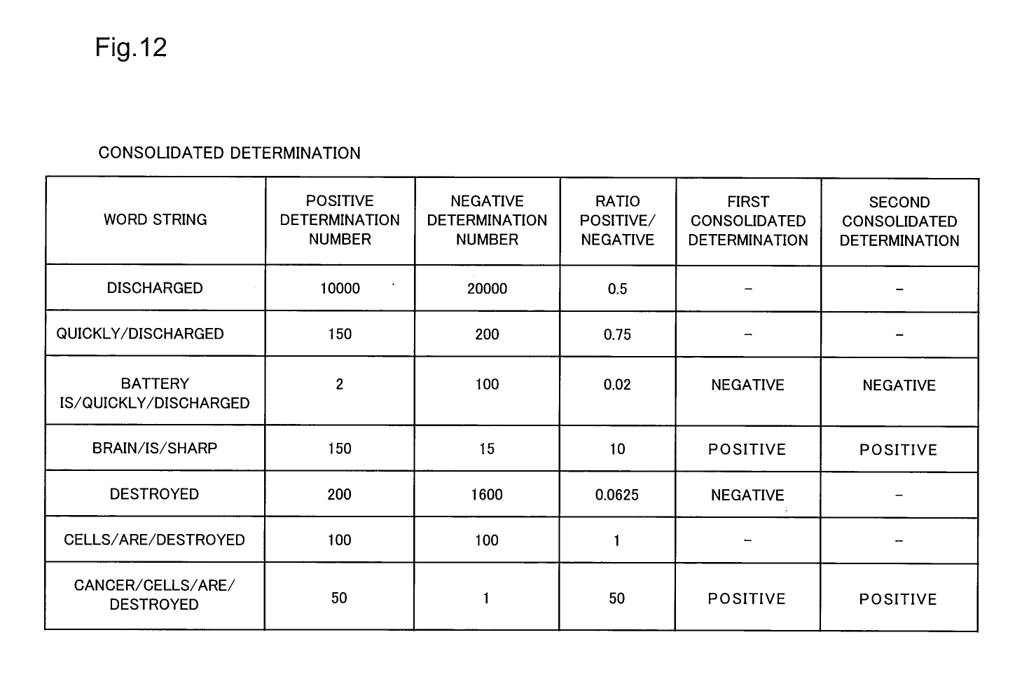

The processing (step S18A) relevant to the first consolidated polarity determination performs a temporal determination prior to a final determination but is substantially the same processing as the processing (step S18) relevant to the consolidated polarity determination of the first exemplary embodiment. FIG. 12 illustrates one example of a consolidated determination result. As a result of the temporal determination, the determination target word strings “Your brain is sharp” and “Cancer cells are destroyed” are determined as positive expressions and the determination target word strings “The battery is quickly discharged” and “destroyed” are determined as negative expressions.

The determination target word string “Cancer cells are destroyed” includes the declinable word “destroyed” and is longer than the declinable word “destroyed.” Further, while the declinable word “destroyed” is a negative expression, the determination target word string “Cancer cells are destroyed” is a positive expression, and then polarity is reversed.

Therefore, the second consolidated polarity determination unit 16B employs only a longer determination target word string “Cancer cells are destroyed” as a determination target and excludes the declinable word “destroyed” from the determination targets (step S18B). As a result of the final determination, the determination target word strings “Your brain is sharp” and “Cancer cells are destroyed” are determined as positive expressions and the determination target word string “The battery is quickly discharged” is determined as a negative expression.

(Effects)

The second exemplary embodiment includes configurations common to the first exemplary embodiment and produces the same effects as the first exemplary embodiment.

Further, using the added configuration (the second consolidated polarity determination unit 16B), the second exemplary embodiment excludes the declinable word “destroyed” from the determination targets. In general, with an increase in word length, the ambiguity of a meaning decreases, resulting in enhancement of the accuracy of a polarity determination. Therefore, the second exemplary embodiment can perform a determination more accurately than the first exemplary embodiment.

<Supplementary Statement>

The inventor of the present invention newly focused attention on the following respect and completed the present invention.

A text to be targeted by the information extraction system of the present invention is one in which a product/service evaluation on a blog or an Internet bulletin board or a complaint and request with respect to a product/service transmitted to a contact center is expressed as a text. Such a text always includes words (or word strings) representing opinions/emotions of a customer with respect to the product/service. In other words, the information extraction system can comprehensively extract opinion/emotion words.

Such opinion/emotion words (or word strings) frequently represent an absolute positive expression or an absolute negative expression having a polarity remaining unchanged regardless of a context.

The information extraction system can accurately determine a polarity of a declinable word co-occurring with an opinion/emotion word based on an absolute positive expression or an absolute negative expression. Further, even when the declinable word is expanded to word strings obtained by linking the declinable word with at least one word, polarity can be accurately determined. In other words, a polarity of a determination target word string remains unchanged regardless of a context.

<Supplementary Notes>

A part or all of the above-described exemplary embodiments can be described as follows but are not limited to the following.

There is proved that an information extraction system including:

an opinion/emotion dictionary that stores opinion/emotion words (or word strings) relevant to absolute positive expressions and opinion/emotion words (or word strings) relevant to absolute negative expressions, the words having a polarity remaining unchanged regardless of a context;

a language analysis unit that acquires an optional character string from a text and performs language analysis for the character string to divide the character string into words and provide a prototype and a part of speech for each of the words;

an opinion/emotion word detection unit that detects an opinion/emotion word (or a word string) from the acquired character string by preforming a matching between the prototype of each of words as the analysis result by the language analysis unit and an opinion/emotion word (or a word string) in the opinion/emotion dictionary;

a declinable word polarity determination unit that determines a polarity of a declinable word based on an absolute polarity of the opinion/emotion word (or the word string) by detecting the declinable word before and after the opinion/emotion word (or the word string) from the acquired character string based on co-occurrence with the opinion/emotion word (or the word string);

a determination range expansion unit that determines polarity by expanding a polarity determination range from the declinable word to word strings obtained by linking the declinable word with at least one word before and after the declinable word;

a determination number tallying unit that tallies a positive determination number and a negative determination number for each determination target word string by repeating a single determination of polarities of the declinable word and the expanded determination target word strings for another character string included in the text;

a consolidated polarity determination unit that performs a consolidated determination whether the determination target word strings are a positive expression or a negative expression based on the positive determination number and the negative determination number; and

an expression extraction unit that extracts a word string (or a word) relevant to a positive expression and a word string (or a word) relevant to a negative expression based on the determination result of the consolidated polarity determination unit.

There is proved that an information extraction system including:

an opinion/emotion dictionary that stores opinion/emotion words (or word strings) relevant to absolute positive expressions and opinion/emotion words (or word strings) relevant to absolute negative expressions, the words having a polarity remaining unchanged regardless of a context;

a language analysis unit that acquires an optional character string from a text and performs language analysis for the character string to divide the character string into words and provide a prototype and a part of speech for each of the words; an opinion/emotion word detection unit that detects an opinion/emotion word (or a word string) from the acquired character string by preforming a matching between the prototype of each of words as the analysis result by the language analysis unit and an opinion/emotion word (or a word string) in the opinion/emotion dictionary;

a declinable word polarity determination unit that determines a polarity of a declinable word based on an absolute polarity of the opinion/emotion word (or the word string) by detecting the declinable word before and after the opinion/emotion word (or the word string) from the acquired character string based on co-occurrence with the opinion/emotion word (or the word string);

a determination range expansion unit that determines polarity by expanding a polarity determination range from the declinable word to word strings obtained by linking the declinable word with at least one word before and after the declinable word;

a determination number tallying unit that tallies a positive determination number and a negative determination number for each determination target word string by repeating a single determination of polarities of the declinable word and the expanded determination target word strings for another character string included in the text;

a first consolidated polarity determination unit that temporarily determines whether the determination target word strings are a positive expression or a negative expression based on the positive determination number and the negative determination number;

a second consolidated polarity determination unit that finally determines only a polarity of a second word string when a first word string (including a declinable word) and the second word string including the first word string and being longer than the first word string exist and a polarity of the first word string and the polarity of the second word string are reversed by the first consolidated polarity determination unit; and

an expression extraction unit that extracts a word string (or a word) relevant to a positive expression and a word string (or a word) relevant to a negative expression based on the determination result of the second consolidated polarity determination unit.

The information extraction system, preferably, wherein

the text is obtained by expressing as a text a product/service evaluation on a blog or an Internet bulletin board or a complaint and request with respect to a product/service transmitted to a contact center.

The information extraction system, preferably, wherein

the consolidated polarity determination unit performs a consolidated determination whether the determination target word strings are a positive expression or a negative expression based on a ratio of the positive determination number and the negative determination number.

The information extraction system, preferably, wherein

the first consolidated polarity determination unit temporarily determines whether the determination target word strings are a positive expression or a negative expression based on a ratio of the positive determination number and the negative determination number.

There is provided an information extraction method including:

acquiring an optional character string from a text and performing language analysis for the character string to divide the character string into words and provide a prototype and a part of speech for each of the words;

detecting an opinion/emotion word (or a word string) from the acquired character string by referring to an opinion/emotion dictionary that stores opinion/emotion words (or word strings) relevant to absolute positive expressions and opinion/emotion words (or word strings) relevant to absolute negative expressions, the words having a polarity remaining unchanged regardless of a context and preforming a matching between the prototype of each of words as the language analysis result and an opinion/emotion word (or a word string) in the opinion/emotion dictionary;

determining a polarity of a declinable word based on an absolute polarity of the opinion/emotion word (or the word string) by detecting the declinable word before and after the opinion/emotion word (or the word string) from the acquired character string based on co-occurrence with the opinion/emotion word (or the word string);

determining polarity by expanding a polarity determination range from the declinable word to word strings obtained by linking the declinable word with at least one word before and after the declinable word;

tallying a positive determination number and a negative determination number for each determination target word string by repeating a single determination of polarities of the declinable word and the expanded determination target word strings for another character string included in the text;

performing a consolidated determination whether the determination target word strings are a positive expression or a negative expression based on the positive determination number and the negative determination number; and

extracting a word string (or a word) relevant to a positive expression and a word string (or a word) relevant to a negative expression based on the consolidated determination result.

There is provided an information extraction method including:

acquiring an optional character string from a text and performing language analysis for the character string to divide the character string into words and provide a prototype and a part of speech for each of the words;

detecting an opinion/emotion word (or a word string) from the acquired character string by referring to an opinion/emotion dictionary that stores opinion/emotion words (or word strings) relevant to absolute positive expressions and opinion/emotion words (or word strings) relevant to absolute negative expressions, the words having a polarity remaining unchanged regardless of a context and preforming a matching between the prototype of each of words as the language analysis result and an opinion/emotion word (or a word string) in the opinion/emotion dictionary;

determining a polarity of a declinable word based on an absolute polarity of the opinion/emotion word (or the word string) by detecting the declinable word before and after the opinion/emotion word (or the word string) from the acquired character string based on co-occurrence with the opinion/emotion word (or the word string);

determining polarity by expanding a polarity determination range from the declinable word to word strings obtained by linking the declinable word with at least one word before and after the declinable word;

tallying a positive determination number and a negative determination number for each determination target word string by repeating a single determination of polarities of the declinable word and the expanded determination target word strings for another character string included in the text;

performing a consolidated determination whether the determination target word strings are a positive expression or a negative expression based on the positive determination number and the negative determination number; and

extracting a word string (or a word) relevant to a positive expression and a word string (or a word) relevant to a negative expression based on the consolidated determination result.

temporarily determining whether the determination target word strings are a positive expression or a negative expression based on the positive determination number and the negative determination number;

finally determining only a polarity of a second word string when a first word string (including a declinable word) and the second word string including the first word string and being longer than the first word string exist and a polarity of the first word string and the polarity of the second word string are reversed; and

extracting a word string (or a word) relevant to a positive expression and a word string (or a word) relevant to a negative expression based on the determination result.

The information extraction method, preferably, wherein

the text is obtained by expressing as a text a product/service evaluation on a blog or an Internet bulletin board or a complaint and request with respect to a product/service transmitted to a contact center.

The information extraction method, preferably, wherein

performing a consolidated determination whether the determination target word strings are a positive expression or a negative expression based on a ratio of the positive determination number and the negative determination number.

The information extraction method, preferably, wherein

temporarily determining whether the determination target word strings are a positive expression or a negative expression based on a ratio of the positive determination number and the negative determination number.

There is provided an information extraction program causes a processing device to execute:

processing for providing a prototype and a part of speech for each word by acquiring an optional character string from a text, performing language analysis for the character string, and dividing the character string into words;

processing for detecting an opinion/emotion word (or a word string) from the acquired character string by referring to an opinion/emotion dictionary that stores opinion/emotion words (or word strings) relevant to absolute positive expressions and opinion/emotion words (or word strings) relevant to absolute negative expressions, the words having a polarity remaining unchanged regardless of a context and preforming a matching between the prototype of each of words as the language analysis result and an opinion/emotion word (or a word string) in the opinion/emotion dictionary;

processing for determining a polarity of a declinable word based on an absolute polarity of the opinion/emotion word (or the word string) by detecting the declinable word before and after the opinion/emotion word (or the word string) from the acquired character string based on co-occurrence with the opinion/emotion word (or the word string);

processing for determining polarity by expanding a polarity determination range from the declinable word to word strings obtained by linking the declinable word with at least one word before and after the declinable word;

processing for tallying a positive determination number and a negative determination number for each determination target word string by repeating a single determination of polarities of the declinable word and the expanded determination target word strings for another character string included in the text;

processing for performing a consolidated determination whether the determination target word strings are a positive expression or a negative expression based on the positive determination number and the negative determination number; and

processing for extracting a word string (or a word) relevant to a positive expression and a word string (or a word) relevant to a negative expression based on the consolidated determination result.

There is provided an information extraction program causes a processing device to execute:

processing for providing a prototype and a part of speech for each word by acquiring an optional character string from a text, performing language analysis for the character string, and dividing the character string into words;

processing for detecting an opinion/emotion word (or a word string) from the acquired character string by referring to an opinion/emotion dictionary that stores opinion/emotion words (or word strings) relevant to absolute positive expressions and opinion/emotion words (or word strings) relevant to absolute negative expressions, the words having a polarity remaining unchanged regardless of a context and preforming a matching between the prototype of each of words as the language analysis result and an opinion/emotion word (or a word string) in the opinion/emotion dictionary;

processing for determining a polarity of a declinable word based on an absolute polarity of the opinion/emotion word (or the word string) by detecting the declinable word before and after the opinion/emotion word (or the word string) from the acquired character string based on co-occurrence with the opinion/emotion word (or the word string);

processing for determining polarity by expanding a polarity determination range from the declinable word to word strings obtained by linking the declinable word with at least one word before and after the declinable word;

processing for tallying a positive determination number and a negative determination number for each determination target word string by repeating a single determination of polarities of the declinable word and the expanded determination target word strings for another character string included in the text;

processing for performing a consolidated determination whether the determination target word strings are a positive expression or a negative expression based on the positive determination number and the negative determination number

processing for extracting a word string (or a word) relevant to a positive expression and a word string (or a word) relevant to a negative expression based on the consolidated determination result processing for temporarily determining whether the determination target word strings are a positive expression or a negative expression based on the positive determination number and the negative determination number;

processing for finally determining only a polarity of a second word string when a first word string (including a declinable word) and the second word string including the first word string and being longer than the first word string exist and a polarity of the first word string and the polarity of the second word string are reversed; and

processing for extracting a word string (or a word) relevant to a positive expression and a word string (or a word) relevant to a negative expression based on the determination result.

The information extraction program, preferable, wherein

the text is obtained by expressing as a text a product/service evaluation on a blog or an Internet bulletin board or a complaint and request with respect to a product/service transmitted to a contact center.

The information extraction program, preferable, wherein performing a consolidated determination whether the determination target word strings are a positive expression or a negative expression based on a ratio of the positive determination number and the negative determination number.

The information extraction program, preferable, wherein temporarily determining whether the determination target word strings are a positive expression or a negative expression based on a ratio of the positive determination number and the negative determination number.

This application is based upon and claims the benefit of priority from Japanese patent application No. 2012-236688, filed on Oct. 26, 2012, the disclosure of which is incorporated herein in its entirety by reference.

### REFERENCE SIGNS LIST

1 processing device
2 storage device
11 language analysis unit
12 opinion/emotion word detection unit
13 declinable word polarity determination unit
14 determination range expansion unit
15 determination number tallying unit
16 consolidated polarity determination unit
16A first consolidated polarity determination unit
16B second consolidated polarity determination unit
17 expression extraction unit
21 opinion/emotion dictionary
22 expression word string dictionary

What is claimed is:

1. An information extraction system comprising:
an opinion/emotion dictionary that stores opinion/emotion words (or word strings) relevant to absolute positive expressions and opinion/emotion words (or word strings) relevant to absolute negative expressions, the words having a polarity remaining unchanged regardless of a context;
a language analysis unit that acquires an optional character string from a text and performs language analysis for the character string to divide the character string into words and provide a prototype and a part of speech for each of the words;
an opinion/emotion word detection unit that detects an opinion/emotion word (or a word string) from the acquired character string by preforming a matching between the prototype of each of words as the analysis result by the language analysis unit and an opinion/emotion word (or a word string) in the opinion/emotion dictionary;
a declinable word polarity determination unit that determines a polarity of a declinable word based on an absolute polarity of the opinion/emotion word (or the word string) by detecting the declinable word before and after the opinion/emotion word (or the word string) from the acquired character string based on co-occurrence with the opinion/emotion word (or the word string);
a determination range expansion unit that determines polarity by expanding a polarity determination range from the declinable word to word strings obtained by linking the declinable word with at least one word before and after the declinable word;
a determination number tallying unit that tallies a positive determination number and a negative determination number for each determination target word string by repeating a single determination of polarities of the declinable word and the expanded determination target word strings for another character string included in the text;
a consolidated polarity determination unit that performs a consolidated determination whether the determination target word strings are a positive expression or a negative expression based on the positive determination number and the negative determination number; and
an expression extraction unit that extracts a word string (or a word) relevant to a positive expression and a word string (or a word) relevant to a negative expression based on the determination result of the consolidated polarity determination unit.

2. An information extraction system comprising:
an opinion/emotion dictionary that stores opinion/emotion words (or word strings) relevant to absolute positive expressions and opinion/emotion words (or word strings) relevant to absolute negative expressions, the words having a polarity remaining unchanged regardless of a context;
a language analysis unit that acquires an optional character string from a text and performs language analysis for the character string to divide the character string into words and provide a prototype and a part of speech for each of the words;
an opinion/emotion word detection unit that detects an opinion/emotion word (or a word string) from the acquired character string by preforming a matching between the prototype of each of words as the analysis result by the language analysis unit and an opinion/emotion word (or a word string) in the opinion/emotion dictionary;
a declinable word polarity determination unit that determines a polarity of a declinable word based on an absolute polarity of the opinion/emotion word (or the word string) by detecting the declinable word before and after the opinion/emotion word (or the word string) from the acquired character string based on co-occurrence with the opinion/emotion word (or the word string);
a determination range expansion unit that determines polarity by expanding a polarity determination range from the declinable word to word strings obtained by linking the declinable word with at least one word before and after the declinable word;
a determination number tallying unit that tallies a positive determination number and a negative determination number for each determination target word string by repeating a single determination of polarities of the declinable word and the expanded determination target word strings for another character string included in the text;
a first consolidated polarity determination unit that temporarily determines whether the determination target word strings are a positive expression or a negative expression based on the positive determination number and the negative determination number;
a second consolidated polarity determination unit that finally determines only a polarity of a second word string when a first word string (including a declinable word) and the second word string including the first word string and being longer than the first word string exist and a polarity of the first word string and the polarity of the second word string are reversed by the first consolidated polarity determination unit; and
an expression extraction unit that extracts a word string (or a word) relevant to a positive expression and a word string (or a word) relevant to a negative expression based on the determination result of the second consolidated polarity determination-unit.

3. The information extraction system according to claim 1 wherein
the text is obtained by expressing as a text a product/service evaluation on a blog or an Internet bulletin board or a complaint and request with respect to a product/service transmitted to a contact center.

4. The information extraction system according to claim 1, wherein
the consolidated polarity determination unit performs a consolidated determination whether the determination target word strings are a positive expression or a negative expression based on a ratio of the positive determination number and the negative determination number.

5. The information extraction system according to claim 2, wherein
the first consolidated polarity determination unit temporarily determines whether the determination target word strings are a positive expression or a negative expression based on a ratio of the positive determination number and the negative determination number.

6. An information extraction method comprising:
acquiring an optional character string from a text and performing language analysis for the character string to divide the character string into words and provide a prototype and a part of speech for each of the words;
detecting an opinion/emotion word (or a word string) from the acquired character string by referring to an opinion/emotion dictionary that stores opinion/emotion words (or word strings) relevant to absolute positive expressions and opinion/emotion words (or word strings) relevant to absolute negative expressions, the words having a polarity remaining unchanged regardless of a context and preforming a matching between the prototype of each of words as the language analysis result and an opinion/emotion word (or a word string) in the opinion/emotion dictionary;
determining a polarity of a declinable word based on an absolute polarity of the opinion/emotion word (or the word string) by detecting the declinable word before and after the opinion/emotion word (or the word string) from the acquired character string based on co-occurrence with the opinion/emotion word (or the word string);
determining polarity by expanding a polarity determination range from the declinable word to word strings obtained by linking the declinable word with at least one word before and after the declinable word;
tallying a positive determination number and a negative determination number for each determination target word string by repeating a single determination of polarities of the declinable word and the expanded determination target word strings for another character string included in the text;
performing a consolidated determination whether the determination target word strings are a positive expression or a negative expression based on the positive determination number and the negative determination number; and
extracting a word string (or a word) relevant to a positive expression and a word string (or a word) relevant to a negative expression based on the consolidated determination result.

7. A non-transitory computer readable medium storing a information extraction program causes a processing device to execute:
processing for acquiring an optional character string from a text and performing language analysis for the character string to divide the character string into words and provide a prototype and a part of speech for each of the words;
processing for detecting an opinion/emotion word (or a word string) from the acquired character string by referring to an opinion/emotion dictionary that stores opinion/emotion words (or word strings) relevant to absolute positive expressions and opinion/emotion words (or word strings) relevant to absolute negative expressions, the words having a polarity remaining unchanged regardless of a context and preforming a matching between the prototype of each of words as the language analysis result and an opinion/emotion word (or a word string) in the opinion/emotion dictionary;
processing for determining a polarity of a declinable word based on an absolute polarity of the opinion/emotion word (or the word string) by detecting the declinable word before and after the opinion/emotion word (or the word string) from the acquired character string based on co-occurrence with the opinion/emotion word (or the word string);
processing for determining polarity by expanding a polarity determination range from the declinable word to word strings obtained by linking the declinable word with at least one word before and after the declinable word;
processing for tallying a positive determination number and a negative determination number for each determination target word string by repeating a single determination of polarities of the declinable word and the expanded determination target word strings for another character string included in the text;
processing for performing a consolidated determination whether the determination target word strings are a positive expression or a negative expression based on the positive determination number and the negative determination number; and
processing for extracting a word string (or a word) relevant to a positive expression and a word string (or a word) relevant to a negative expression based on the consolidated determination result.

8. An information extraction system comprising:
an opinion/emotion dictionary that stores opinion/emotion words (or word strings) relevant to absolute positive expressions and opinion/emotion words (or word strings) relevant to absolute negative expressions, the words having a polarity remaining unchanged regardless of a context;
a language analysis unit that acquires an optional character string from a text and performs language analysis for the character string to divide the character string into words and provide a prototype and a part of speech for each of the words;
an opinion/emotion word detection unit that detects an opinion/emotion word (or a word string) from the acquired character string by preforming a matching between the prototype of each of words as the analysis result by the language analysis unit and an opinion/emotion word (or a word string) in the opinion/emotion dictionary;
a declinable word polarity determination unit that determines a polarity of a declinable word based on an absolute polarity of the opinion/emotion word (or the word string) by detecting the declinable word before and after the opinion/emotion word (or the word string) from the acquired character string based on co-occurrence with the opinion/emotion word (or the word string);
a determination range expansion unit that determines polarity by expanding a polarity determination range from the declinable word to word strings obtained by linking the declinable word with at least one word before and after the declinable word;
a determination number tallying unit that tallies a positive determination number and a negative determination number for each determination target word string by repeating a single determination of polarities of the declinable word and the expanded determination target word strings for another character string included in the text;
a consolidated polarity determination unit that performs a consolidated determination whether the determination target word strings are a positive expression or a negative expression based on the positive determination number and the negative determination number; and
an expression extraction unit that extracts a word string (or a word) relevant to a positive expression and a word string (or a word) relevant to a negative expression based on the determination result of the consolidated polarity determination unit.
